(19) United States
(12) Patent Application Publication
(10) Pub. No.: US 2002/0138169 A1
(43) Pub. Date: Sep. 26, 2002

(54) Device for calculating overall plant efficiency

(76) Inventor: Mitsuo Sakaguchi, Kariya-shi (JP)

Correspondence Address: FLYNN, THIEL, BOUTELL & TANIS, P.C., 2026 Rambling Road, Kalamazoo, MI, 49008-1699, US

(21) Appl. No.: 10/099,320

(22) Filed: Mar. 15, 2002

(30) Foreign Application Priority Data
Mar. 22, 2001 (JP) 2001-82402

(51) Int. Cl. G06F 19/00

(52) U.S. Cl. 700/108; 700/109; 700/111

(57) ABSTRACT

The present invention provides an index to make possible the evaluation of production efficiencies of a plant and provides a device for calculating that index. The device for calculating the overall plant efficiency according to the present invention comprises: (1) a means for calculating an availability, (2) a means for calculating a performance rate, (3) a means for calculating a quality rate, and a means for calculating the overall plant efficiency which is a product of items (1) through (3). The ratios (1) through (3) are indices reflecting categories in which all the factors causing reductions in the production efficiency of the plant are collected and categorized. The overall plant efficiency is an index whereby those items are comprehensively evaluated and the extent of assets utility can be evaluated.

### BACKGROUND OF THE INVENTION

1. Field of the Invention

The present invention relates to a device for correctly calculating the current production efficiency of a process-type plant in order to further improve the production efficiency.

2. Description of the Related Art

In manufacturing work in a process-type plant, such as a chemical plant and an oil-refining plant, it is mostly the case that manufacturing one product requires a plurality of reaction processes. In other words, a plurality of facilities are operated in order to manufacture one product. Conventionally, in order to reduce manufacturing costs for that product and in order to improve the production efficiency, whether a failure occurs among the equipment or not, and, how the availability of the equipment is, are only considered. Then, these indices are estimated and automation is performed so as to reflect the estimation to the production efficiency.

On the other hand, in the plant which has a plurality of facilities, source materials are continuously thrown into the plant and transported, then, such plant has a side that the plant as a whole works together as a single manufacturing facility. Therefore, it is difficult to estimate the production efficiency of the equipment of individual reaction processes or treatment processes, and also difficult to estimate the extent of assets utility of the entire plant, based on the production efficiencies of individual facilities. Moreover, since each of equipment of a plant is generally stopped once in a year in many cases (a scheduled shutdown), the all countermeasures determined by accumulating daily planning of countermeasures have to be securely applied. The inventor paid attention to these aspects and suggested the overall plant efficiency mentioned later, which reflects equally the production efficiencies of individual facilities and serves as an index for calculating an overall production efficiency of the whole plant.

However, in calculating the overall plant efficiency, it is necessary to carry out complicated measurements corresponding to each of facilities. For example, for one facility, it is continually necessary to measure periodically detailed machine stoppages and idling time, operating rate of the machine, detecting reaction conditions such as a temperature and a pressure and tons (t) of a final non-defective product, and making the calculation using those data. For this reason, particularly in the case where there is a large number of facilities and a material passes through complex reaction processes, time and staff are necessary just in order to find the production efficiency and this is contrary to the original object of improving production efficiency of the plant. Furthermore, as the quantity of that collected data grow, statistical analysis for trends in the history and equipment deterioration becomes difficult. Even if the index proposed by the inventor is used, it is difficult to accurately evaluate an index with relation to a production rate such as performance rate mentioned in the below, and, it is still difficult to periodically compare changes of values of the index between different plants or in the same plant. Consequently, in order to improve the production efficiency for the entire plant, a device for calculating continuously and managing the production efficiency using the index is required and it is desirable to advance the automation of a plant further.

### SUMMARY OF THE INVENTION

Corresponding to the above-mentioned requirements, the present invention provides a device for calculating an overall plant efficiency for evaluating a production efficiency of equipment in a plant and comprising:

a means for calculating an availability;

a means for calculating a performance rate;

a means for calculating a quality rate; and

a means for calculating a product of said availability, said performance rate, and said quality rate.

As a result of comparing and examining the current problems of a process-type plant in manufacturing various types of products, the inventor proposed a device for calculating the index reflecting the production efficiency of the whole plant and that could be applied to any type of plant. That index is the overall plant efficiency and is defined as follows.

(Overall plant efficiency)≡(Availability)×(Performance rate)×(Quality rate)

The availability, the performance rate, and the quality rate are numerical values derived from collecting all of the various factors expected to reduce the production efficiency of the plant, classifying those into eight categories, and the values are acquired and calculated in accordance with the categories. The definitions of the availability, the performance rate, and the quality rate are explained below. FIG. 1 shows an explanatory diagram showing how to calculate the availability, the performance rate, and the quality rate in order to obtain the overall plant efficiency. The left portion of FIG. 1 shows the concept of the actual operating time of a plant with respect to a calendar time and the central portion shows the eight categories of factors reducing the production efficiency. The right portion shows the mathematical equations of the availability, the performance rate and the quality rate.

(1) Availability

The availability is calculated by subtracting the time in which the equipment is stopped because of the following factors 1 and 2 from the calendar time (it is called as working time), and further subtracting the time in which the equipment is stopped due to the factors 3 and 4 (it is called as operating time). The stoppage times resulting from those factors are as follows.

1. Shutdown maintenance: The time in which equipment is stopped because of a shutdown construction of annual scheduled maintenance of each of the equipment, a periodic overhaul and a legal check.

2. Production adjustment: The time in which the equipment is stopped from a point of view of production planning because of fluctuation of supply and demand, such as a stoppage due to production adjustment and stock adjustment.

3. Equipment failure: The time in which the equipment is suddenly stopped because the equipment or machinery loses its regular function, such as pump trouble, motor burning and bearing broken.

4. Process failure: The time in which the equipment is stopped because of a chemical or physical reason such as a property of handling materials, and of mishandling in the processes such as a leak or a drop of the materials and mistakes at the operation. Consequently, the availability is calculated with the following formula.

(Availability (%))=(Calendar time-(1+2+3+4))/(Calendar time) ×100

When calculating the overall plant efficiency, use the value that is not multiplied by 100.

(2) Performance rate

Further reductions in the production efficiency with respect to the above-mentioned operating time due to the performance of the equipment are considered. The factors 5 and 6 derived from the performance of the equipment are classified as follows.

5. Normal performance reduction: The reduction of the production rate because of startup after turning the equipment on, cooling down before turning the equipment off, and change of kinds.

6. Abnormal performance reduction: The reduction of the production rate because of malfunction or abnormality of the plant such as low load running and low speed running. The production efficiency reduced by 5 and 6, namely the performance rate, is calculated as follows using a design standard rate in which a kind of products is manufactured by use of the equipment, i.e. an ideal production rate (t/time), and using the actual average production rate derived by dividing a real production amount, i.e. an actual production amount, with the operating time.

(Performance rate (%))=(Actual average production rate)/(Ideal production rate)×100

(Actual average production rate (t/time))=(Actual production amount)/(Operating time)

When calculating the overall plant efficiency, use the value that is not multiplied by 100.

(3) Quality rate

Other factors than the above 1 to 6 which reduces the production efficiency of the equipment are mainly production of defectives and the factors are categorized as follows.

7. Process defect: Reduction of the production amount because of generating products out of a standard quality such as a product discarded and degraded to seconds.

8. Reprocessing: Reduction of the production amount because of recycling defective product from the final step into the headstream step in order to reprocess the defective to non-defective.

Consequently, the production efficiency resulting from the factors 7 and 8 is calculated as follows as the quality rate.

(Quality rate (%))=((Production amount)−(7+8))/ (Production amount)×100

When calculating the overall plant efficiency, use the value that is not multiplied by 100.

The factors predicted to bring about a reduced production efficiency in the various equipment of a plant are all included in the above-mentioned items 1 through 8. Consequently, the overall plant efficiency for each facility is attained as an overall index reflecting all of the factors 1 through 8, regardless of which is the principal factor. The overall plant efficiency enables to estimate the plant until the final product is completed, thereby, the overall plant efficiency can estimate the extent of assets utility. Furthermore, in the case where there is a sudden drop in the overall plant efficiency for any facility, it becomes possible to discover the malfunctioning equipment quickly and take countermeasures through research and analysis of whether the drop occurred because of one of the items 1 through 8 and where the cause occurred.

The availability is calculated by inputting to a computer, such as a personal computer, the calendar time, 1 and 2 as existing data, and the measured stoppage time due to the factors 3 and 4 as measured data during operation. These input data and the availability are preferably made into a database, with the stoppage time classified by items 1 through 4 for the input data, and the tendency over time accumulated. In this way, for example, if the situation arises wherein the stoppage time due to the equipment failure of item 3 gradually increases and the overall plant efficiency is reduced, it becomes easy to take countermeasures, for example, the equipment maybe adjusted or repaired at some period.

In order to acquire the performance rate, the ideal production rate according to the design standard as existing data and the measured actual production amount as measured data during operation are input to a computer such as a personal computer. The performance rate is calculated using these input data and the operating time calculated with data input when calculating the availability. These input data and the performance rate are preferably made into a database like the availability and the tendency over time accumulated.

The quality rate is calculated by measuring total production amount, amount of defective product and that of recycling at the final step of the plant, inputting these data to a computer such as a personal computer and calculating. For these input data and the quality rate as well, it is preferable that a record be made every day and the tendency over time accumulated, as is done for the availability and the performance rate.

The overall plant efficiency is calculated for each of the facilities with a computer such as a personal computer using the data calculated for the availability, the performance rate and the quality rate as discussed above. So long as it comprises an input function, a memory device, a calculation processing function, and a display device, the device for calculating the overall plant efficiency relating to the present invention may be a single computer such as a personal computer used when calculating the availability, the performance rate, the quality rate and the overall plant efficiency, or a plurality of computers connected over a network. A plurality of input devices and display devices may also be provided for a single calculation-processing unit. It is also possible to automate the measurements of time and quantity for each process and input the data from those measurement devices to a personal computer or the like through an interface board or the like. It is preferable that the measurement data be acquired automatically in order to save time.

By use of the device for calculating the overall plant efficiency relating to the present invention, it is preferable to calculate quickly the production efficiency for each of plants in the case of a plurality of plants and also to collect and manage those production efficiencies in a single location. By the above-mentioned automatic acquisition of the measured data and by continually displaying the data, an operator can grasp not only whether the production efficiency of the whole plant is steadily maintained or not, but also whether each facility normally works or not. Especially, the performance rate can be accurately calculated although such calculation is conventionally difficult, thereby, the tendency of the performance rate is traceable throughout the year. Therefore, by use of such a program as displaying trend of the performance rate relative to each of the facilities in a long term, and as warning in the case of detecting a drop of the performance rate from a standard level, deterioration of the equipment is found and a countermeasure is applied during the scheduled shutdown.

Furthermore, the device for calculating the overall plant efficiency relating to the present invention can also calculate deviation from target values, based on a production plan, for the overall plant efficiency. Such device for calculating the overall plant efficiency is particularly useful when manufacturing many different kinds of products (a plurality of batches) in the same plant throughout the year. The daily production goal is set with the shipping plan for each kind of products. The target for overall plant efficiency is established according to this production target. For example, an ideal production rate of a certain product is 1 t/hour, and the plan is to produce 100 t of the product. The time frame for this plan is an idealized time plan established without shutdown or failure of the equipment, other stoppages, reduced performance of the equipment, or defectives. In other words, the operating time is 1 t/hour×100 t=100 hours; and the availability is 100%, the performance rate is 100% without any performance reductions, and the quality rate is 100% without any defective. The overall plant efficiency in this case becomes 100%. When 100 t of the product is actually produced, however, measurement results show that it took 200 hours. At this time, the overall plant efficiency is 50%. In this case, by use of the present calculating device, the fluctuation can be quickly found by utilizing the overall plant efficiency from a point of view of productivity. Additionally, in order to determine the cause thereof, it can be automatically and instantly found for each of the facilities whether this is due to a stoppage of the equipment causing a reduction in the pre-established target availability, a reduced equipment performance such as an decrease in the standard production rate reducing the target performance rate, or the output of defective product reducing the target quality rate. In general cases, in one year's operations, a composite production plan for manufacturing a plurality of batches is established and carried out. In this case, for example, it is instantly revealed which batch was delayed and caused failure of the production plan. Moreover, in the case of finding the overall plant efficiency for a composite production, this is expressed as follows.

(Sum of overall plant efficiencies per batch)/ (The number of bathes)

In the case of establishing the target values according to a production plan in the device for calculating the overall plant efficiency, a target overall plant efficiency corresponding to each kind of batches and quantity thereof to be produced may be input in advance to the device, and a comparison may be made with the overall plant efficiency based on the measured data. By acquiring the deviations from the target values in this way, the device can clearly determine whether the individual batches were manufactured ideally or whether the production efficiency dropped. In other words, the target value provides a clear, quantitative standard for determination. Consequently, the device can transmit an indication of whether to take countermeasures, such as inspection or repair of the equipment, to an operator automatically according to this determination standard. This type of determination may be made at all times, but can also be recorded and the indication can be made so as to achieve maintenance and check certainly at the scheduled shutdown.

### BRIEF DESCRIPTION OF THE DRAWINGS

FIG. 1 is a drawing to explain the overall plant efficiency; and

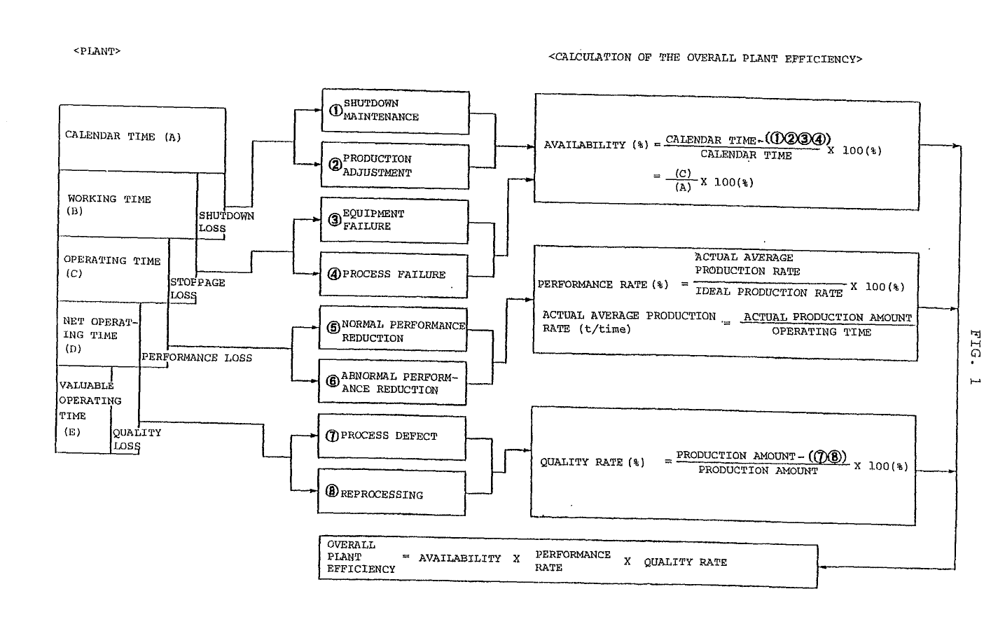

FIG. 2 is a drawing showing an example of the data collected in order to calculate the overall plant efficiency.

### DETAILED DESCRIPTION OF THE PREFERRED EMBODIMENTS

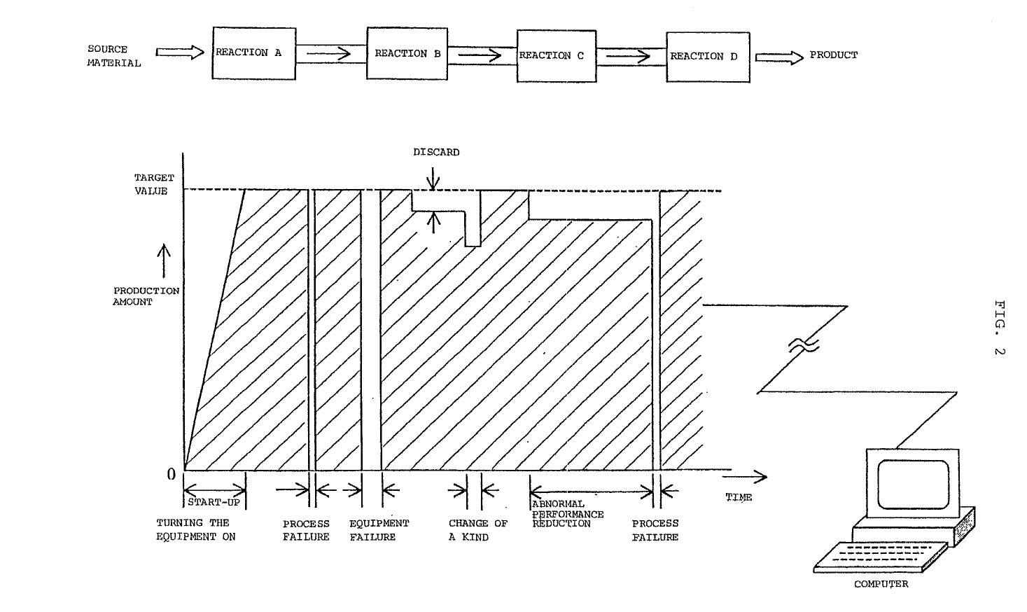

The preferred embodiments of the present invention are explained below using the example shown in FIG. 2. The upper portion of FIG. 2 show the flows in a plant from when a source material is introduced, and that material is successively treated through the four reaction processes A, B, C and D, i.e. four facilities, until a final product is send out. In this plant, the source material is continuously thrown into the plant after turning each facility on and starting up, and the product is also continuously manufactured during the operating time almost all the year round.

The graph in the center of FIG. 2 shows the data collected for calculating the overall plant efficiency; the horizontal axis shows the working time and the vertical axis shows the production amount. The production amount is measured after the material passing through the last reaction process D, as the final production amount. At first, the production amount gradually increased from zero until each of the facilities is completely ready. Next, the graph shows a temporary stoppage of the production owing to a process failure. In the stoppage, if a liquid drop occurred at the equipment treating the reaction process B, such data as the place in which the process failure developed and the cause in detail are input. After that, the graph also shows that the equipment failure occurred and the manufacturing was stopped for a while. The place of the accident and the concrete cause, such as a pump malfunctioning in the equipment of the reaction process B, are similarly input. Then, for example, a temperature at the equipment carrying out the reaction process C temporary increased and a part of the product had to be discarded, the actual production amount derived by subtracting the discarded quantity is recorded with determination of the cause. As shown in the graph, when the facility was transitory run with a low speed for manufacturing a product of a different batch (a different kind), this operation and the production amount is recorded together. Moreover, if a pressure in the reaction process D increased and then equipment thereof was operated with a low speed, the decreased production amount due to the abnormal performance reduction, the place and the cause are recorded. In this way, the data for calculating the overall plant efficiency are continuously acquired during the working time.

In order to acquire this type of data, in addition to automatic measurement of the production amount, measured data that directly reflect the equipment operation rate, such as a current load flowing into the equipment's machinery or a turnover rate of the machine, are automatically stored in the computer. Thereby, the facility where the failure developed can be easily determined. In the case that the equipment is stopped, the type of cause may be input as supplementary data; for example, the type of cause may be established in advance in order to classify automatically, such as classifying a change in the predetermined reaction conditions only as the process failure by detecting the temperature or the pressure, and classifying another mechanical failure of the equipment as the equipment failure.

With the device according to the present invention, a high level of production efficiency is continuously maintained for each of the equipment and further automation of the plant is realized. By use of the device for calculating the overall plant efficiency relating to the present invention, it becomes possible to collect and manage those production efficiencies in a single location and also to decrease costs by reducing staff and time. Moreover, the production efficiency of the plant as a whole is continually grasped, and especially, an index which reflects the production rate of each facility is given because the device enables to evaluate the performance rate accurately. Also, by accumulating the measured data and calculated data used for calculating the overall plant efficiency, analysis of the causal factors can be done easily using this accumulation of data, and a response can be made quickly. Namely, the device for calculating the overall plant efficiency of the present invention becomes a device for estimating the extent of assets utility.

What is claimed is:

1. A device for calculating a overall plant efficiency for evaluating a production efficiency of equipment in a plant and comprising:
a means for calculating an availability;
a means for calculating a performance rate;
a means for calculating a quality rate; and
a means for calculating a product of said availability, said performance rate, and said quality rate.

2. The device for calculating a overall plant efficiency according to claim 1, further comprising a means for calculating a deviation from a target value according to a production plan, with respect to a product of said availability, said performance rate, and said quality rate.
